(19) United States
(12) Patent Application Publication
(10) Pub. No.: US 2003/0123457 A1
(43) Pub. Date: Jul. 3, 2003

(54) Apparatus and method for distributed software implementation of OSPF protocol

(76) Inventor: Pramod V.N. Koppol, Aberdeen, NJ (US)

Correspondence Address: Docket Administrator (Room 3J-219), Lucent Technologies Inc.,, 101 Crawfords Corner Road, Holmdel, NJ, 07733-3030, US

(21) Appl. No.: 10/033,512

(22) Filed: Dec. 27, 2001

(51) Int. Cl. H04L 12/28; H04L 12/56

(52) U.S. Cl. 370/400; 370/392

(57) ABSTRACT

The present invention is an OSPF flooding proxy mechanism for taking advantage of a distributed hardware architecture to achieve a highly scaleable OSPF implementation capable of supporting a large number of nodes in an area. Given the widespread interest in MPLS explicit route based traffic engineering within an autonomous system and given that most TE mechanisms work best when complete network topology is available, such an OSPF implementation is highly desirable. Also, the next generation terabit router architectures with multiple levels of processor hierarchies and spanning multiple shelves make such protocol implementations very compelling. One embodiment of the invention includes an apparatus for communicating an intra-autonomous system link state routing protocol with nodes in a network. The apparatus includes a controller having at least one processor associated therewith for performing route calculation and maintaining a link state database of said network. At least one delegate port card is coupled to the controller and has at least one separate processor associated therewith. The delegate port card has selected software functionality of the intra-AS link state routing protocol assigned thereto. The delegate port card is operable to process communications associated with said selected software functionality substantially independently of said controller.

### FIELD OF THE INVENTION

The present invention relates generally to the field of Internet Protocol (IP) networks, and more specifically to the field of deployment of traffic engineering (TE) within such networks.

### BACKGROUND OF THE INVENTION

OSPF is a link state routing protocol. Adjacent devices within a network exchange information in the form of link state advertisements in such a way that all nodes in the network have a consistent link state database at their disposal. Each node then uses this link state database to make routing decisions. In order to avoid faulty routing, it is imperative that all nodes converge to a common view of the network and each node make routing decisions in a manner consistent with the rest of the nodes in the network To achieve convergence, OSPF defines procedures for reliable flooding information originated by any node to the rest of the network Consistent routing is achieved in OSPF by mandating that each node route IP datagrams along the shortest path from itself to the destination specified in the IP datagram.

The size of the link state database and the stability of the network are two important factors that contribute to stable operation of the OSPF protocol in a network In addition to the number of nodes and links in the network, the size of the link state database is also a function of the number of route prefixes external to the OSPF routing domain whose reachability is shared within the OSPF domain using the OSPF protocol mechanisms. In an unstable network where certain links and/or nodes constantly fail and recover, the operational nodes are forced to constantly exchange information through flooding in order to keep their link state databases synchronized.

OSPF allows for a two level hierarchical network where logical nodes of this hierarchy are called areas and a root node is called a backbone area. Routing between any two non-backbone areas is always through the backbone area. At the border of any two areas, topology information of each of the areas is summarized into route prefix reachability information by the border node before flooding this information to the other area. The rationale of providing this hierarchical mechanism is twofold. A first consideration is to reduce the size of the link state database at each node in the network. A second consideration is to provide some isolation between stable and unstable portions of the network.

Recently, there has been an interest in using the link state database to compute explicit paths between edge nodes to support MPLS (multi-protocol label switching) based traffic engineering (TE). Additional information that needs to become part of the link state database is defined in extensions to the OSPF protocol. Also, the hierarchy of a network must be chosen carefully so as not to significantly compromise near optimal routing. While TE mechanisms suitable for hierarchical networks are being studied, it is clear that best TE results can be achieved in a single area network.

In addition to the TE issues, area configuration is cumbersome and can be error prone. Inadequate summarization can lead to increased configuration effort without achieving the objectives of splitting into areas. Also, summarization is only applied to topology information, not applied to external prefixes. Therefore, in cases where nodes within an area advertise large numbers (compared to the size of the area topology) of external prefixes, the size of the link state database may not be significantly reduced.

Accordingly, there is a need for an OSPF implementation that pushes the limits on the capacity of a node in an OSPF network to be highly scaleable in terms of the size of the network and resilience to instability. Further motivation is provided by recent interest in building extremely high capacity nodes with potentially large number of OSPF speaking interfaces.

### SUMMARY OF THE INVENTION

The present invention is an OSPF flooding proxy mechanism for taking advantage of a distributed hardware architecture to achieve a highly scaleable OSPF implementation capable of supporting a large number of nodes in an area. Given the widespread interest in MPLS explicit route based traffic engineering within an autonomous system, and given that most TE mechanisms work best when complete network topology is available, such an OSPF implementation is highly desirable. Also, the next generation terabit router architectures with multiple levels of processor hierarchies and spanning multiple shelves make such protocol implementations very compelling.

One embodiment of the invention includes an apparatus for communicating a link state routing protocol with nodes in a network. The apparatus includes a controller having at least one processor associated therewith for performing route calculation and maintaining a link state database of said network. At least one delegate port card is coupled to the controller and has at least one separate processor associated therewith. The delegate port card has selected software functionality of the link state routing protocol assigned thereto. The delegate port card is operable to process communications associated with said selected software functionality substantially independently of said controller.

### BRIEF DESCRIPTION OF THE DRAWINGS

A more complete understanding of the present invention may be obtained from consideration of the following detailed description of the invention in conjunction with the drawing, with like elements referenced with like references, in which:

FIG. 1A is an illustration of an exemplary first generation router/packet switch architecture;

FIG. 1B is an illustration of an exemplary second generation router/packet switch architecture;

FIG. 1C is an illustration of an exemplary third generation router/packet switch architecture;

FIG. 1D is an illustration of an exemplary fourth generation router/packet switch architecture;

FIG. 2 shows a router having exemplary network interfaces for an exemplary OSPF network;

FIG. 3 shows an exemplary interface finite state machine;

FIG. 4 shows an exemplary neighbor finite state machine;

FIG. 5 shows an exemplary arrangement of a port card and controller in accordance with the present invention;

FIG. 6 illustrates an initial database exchange process in accordance with the present invention;

FIG. 7 illustrates a distributed flooding functionality in accordance with the present invention; and

FIG. 8 illustrates the distributed processing of incoming LSA updates in accordance with the present invention.

### DETAILED DESCRIPTION

Although the present invention is described in connection with the OSPF routing protocol, it would be understood that the invention would also be applicable to other routing protocols including, but not limited to, PNNI and ISIS (Intermediate System to Intermediate System).

OSPF is a widely deployed intra-AS (autonomous system) link state routing protocol. OSPF uses reliable flooding mechanisms to disseminate advertisements. Three main functions handled by OSPF are flooding, SPT (shortest path tree) computation and routing table updates and neighbor maintenance. OSPF supports a two level hierarchy to localize flooding and faults. As discussed in the background, there has recently been significant interest in Intra-AS traffic engineering, where extensions are being made to OSPF to support TE. This increases the information that is exchanged by OSPF and as a result of the TE causes more frequent SPT computations.

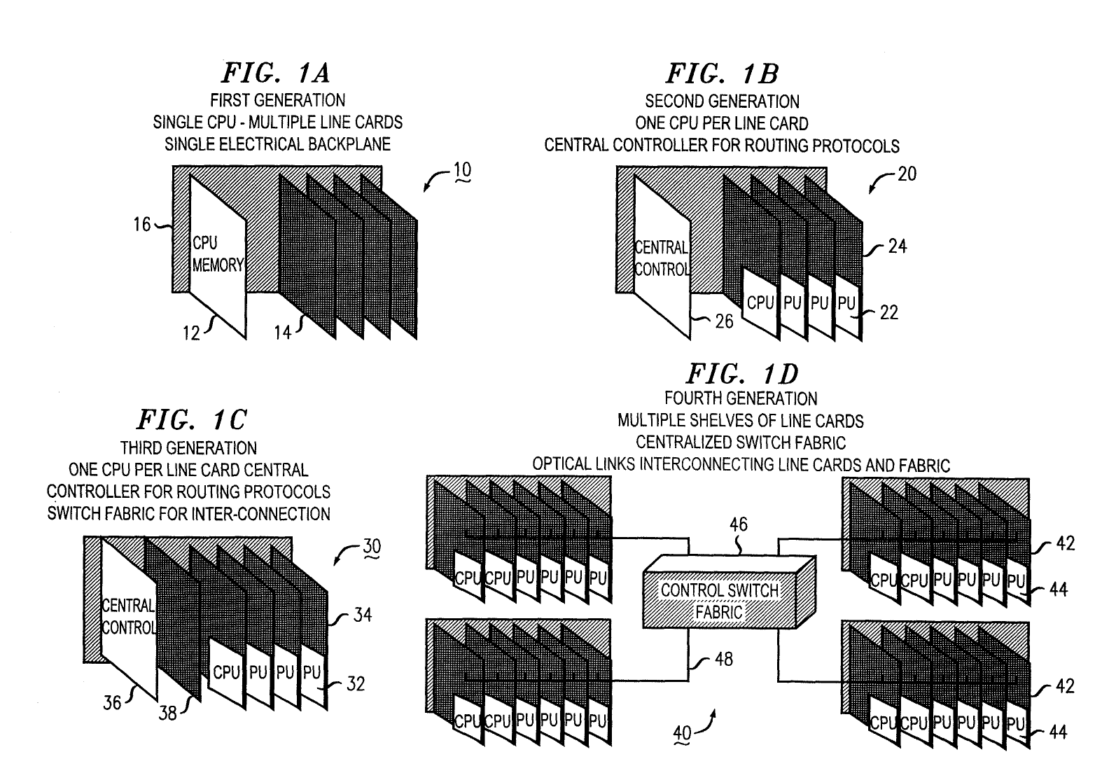

Along with the development of traffic engineering principles, advanced router/packet switch architectures have also evolved. Referring to FIG. 1A, for example, a first generation packet switch 10 is illustrated which includes a single CPU 12 with multiple line cards 14 connecting on a single backplane 16. FIG. 1B shows an exemplary second generation packet switch architecture 20 that includes one CPU 22 per line card 24 with a central controller 26 assigned for processing of the routing protocols. A third generation packet switch architecture 30 is shown in FIG. 1C which shows a system having one CPU 32 per line card 34, a central controller 36 for handling routing protocol processing and a switch fabric 38 utilized for interconnection purposes. An exemplary fourth generation packet switch/ architecture 40 shown in FIG. 1D may include multiple shelves of line cards 42 having individual CPUs 44, a centralized switch fabric 46 and optical links 48, for example, interconnecting the line cards 42 and the switch fabric 46.

As these routers have developed with large numbers of interfaces and high processing power there is increased interest in traffic engineering. There is also interest in millisecond convergence with possible subsecond hellos and frequent SPT computation.. Configuring a large number of areas, however, can increase the potential for human error. In order to address some of the above concerns, some router architectures scale the forwarding capacity of the router by distributing the forwarding functionality to the line cards. This is possible, since the line cards usually have a reasonably powerful CPU that in many cases is under-utilized. In such a case, all control software would still run on a single controller card.

The present invention significantly expands the distributed hardware concept by also distributing some software functionality to the line cards. As will be explained in greater detail herein, the receiving of LSAs, the reliable flooding function and hello processing and leader election functionality are advantageously distributed to the line cards. In addition, the present invention operates with hot swappable line cards and does not make any changes to the protocol itself.

RFC 2328 is a primary reference for information on OSPFv2. What follows in the next few sections of the detailed description is a brief overview of the OSPF protocol as it is related to the present invention. Thereafter, the present invention is explained as it relates to sections that were previously introduced.

OSPF Interface Types and Speaker Capacity

OSPF can be used in connection with various interfaces such as: point to point interfaces, broadcast interfaces, non-broadcast multi-access interfaces, point to multi-point and virtual point to point. A packet over SONET (POS) interface on a router that connects to another router within the same OSPF domain is an example of an OSPF point to point interface. An ethernet port over which a router connects to one or more other routers in the same OSPF domain is an example of an OSPF broadcast interface. Non broadcast multi-access (NBMA) interfaces simulate broadcast interface functionality when the underlying physical medium does not support broadcast. OSPF treats broadcast interfaces and NBMA interfaces in very similar terms. In OSPF, point to multipoint links are treated as being similar to a set of point to point links. Therefore, the present invention works without any new issues on point to multipoint links. However, the applicability of the present invention as it relates to virtual links is not specifically addressed.

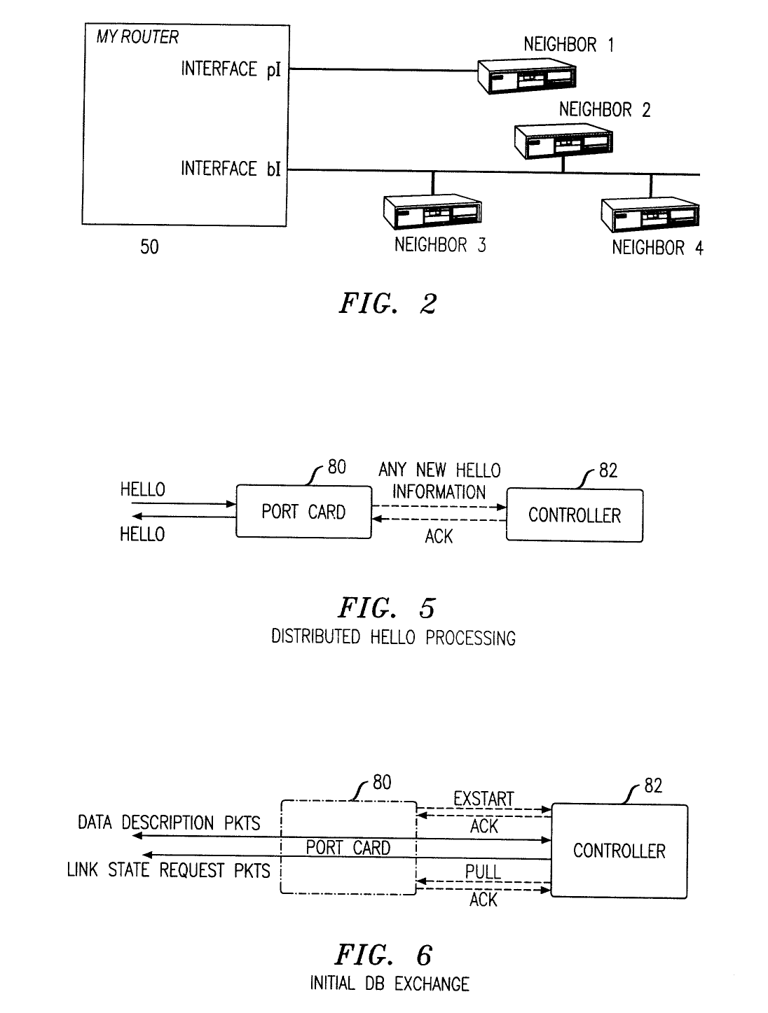

FIG. 2 shows a point to point interface “pI” and a broadcast interface “bI” for an exemplary router 50. For broadcast and NBMA interfaces, one of the routers on that network is elected to be a designated router (DR). Only the DR advertises the information about the network while all others just advertise their link to the network. For fault tolerant operation, a backup DR (BDR) is also elected. If a router is neither a DR nor a BDR on an interface, it is expected to participate in the capacity of DROther on that interface.

Content at Each OSPF Node

Each node in an OSPF network has a link state database (LSDB) comprised of link state advertisements (LSAs). At a given node, these LSAs are either self originated, or are obtained from a neighbor using the OSPF protocol. The following types of LSAs are defined: Router LSA, Network LSA, External LSA, Summary LSA, ASBR-summary LSA, NSSA LSA, and Opaque LSA. As is understood, the router LSAs and the network LSAs together provide the topology of an OSPF area. Each LSA has a standard header that contains advertising router id, LStype, LS id, age, seqnum and a checksum. The LS type, LS id and the Advertising router id together identify a LSA uniquely. For each LSA in the LSDB, the checksum is verified every checkage seconds, where if this check fails, it is an indication that something has gone wrong on the node. For multiple instances of an LSA, the fields age, seqnum and the checksum are used in comparing them, in which: (1) the version with the higher sequence number (seqnum) is more recent, (2) if same sequence number, then the version with the higher checksum is more recent, (3) if same checksum, then the version with age equals maxage is more recent, (4) if none of the instances has age equals maxage, if the difference in the age of the two versions is less than maxagediff, the version with the smaller age is more recent, (5) otherwise, the two instances are the same.

At a given node in an OSPF network, the node keeps a link state database (LSDB) comprised of link state advertisements (LSAs). LSAs are originated by each node in the OSPF domain and are flooded to every node in the domain. The objective of the OSPF flooding procedure is to keep the LSDBs at all the nodes in the domain synchronized.

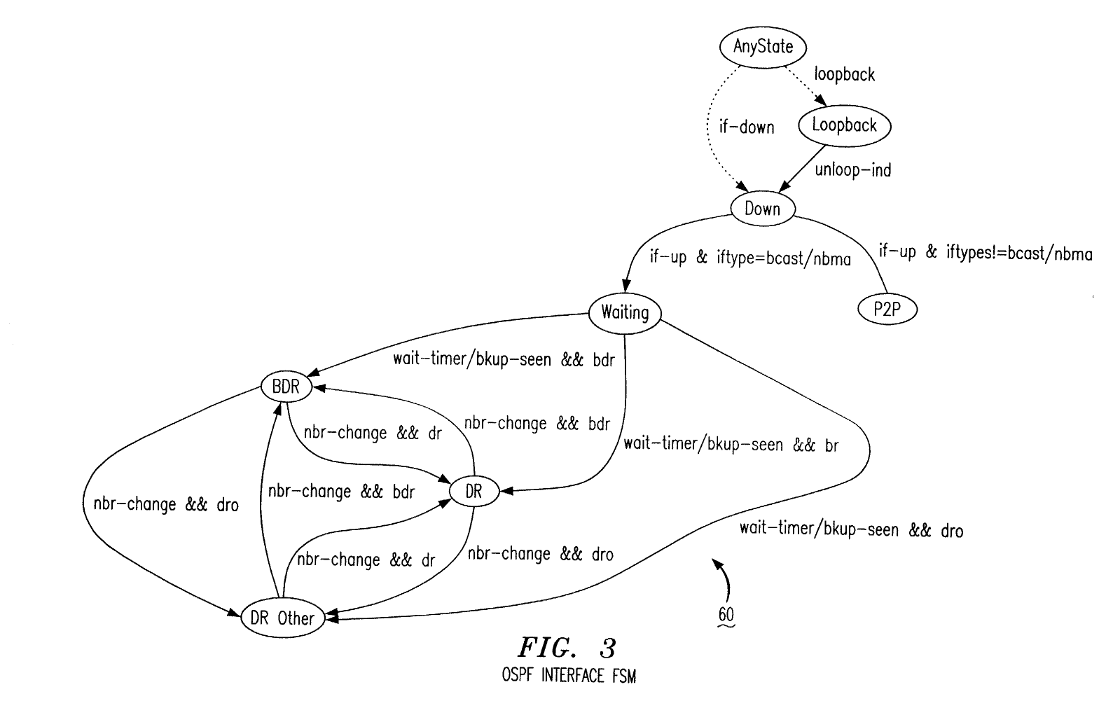

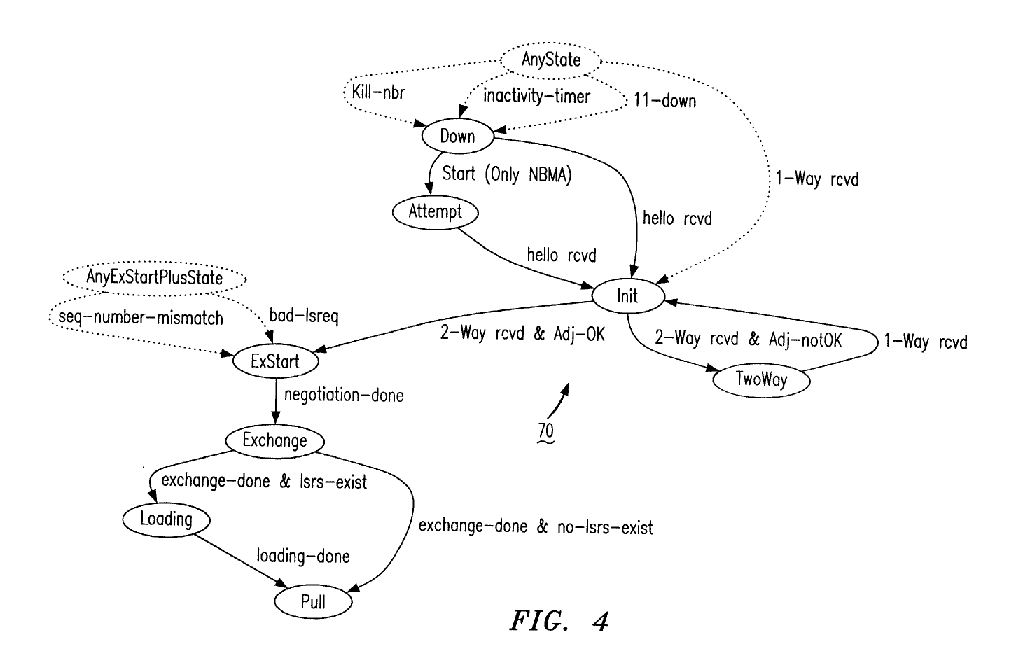

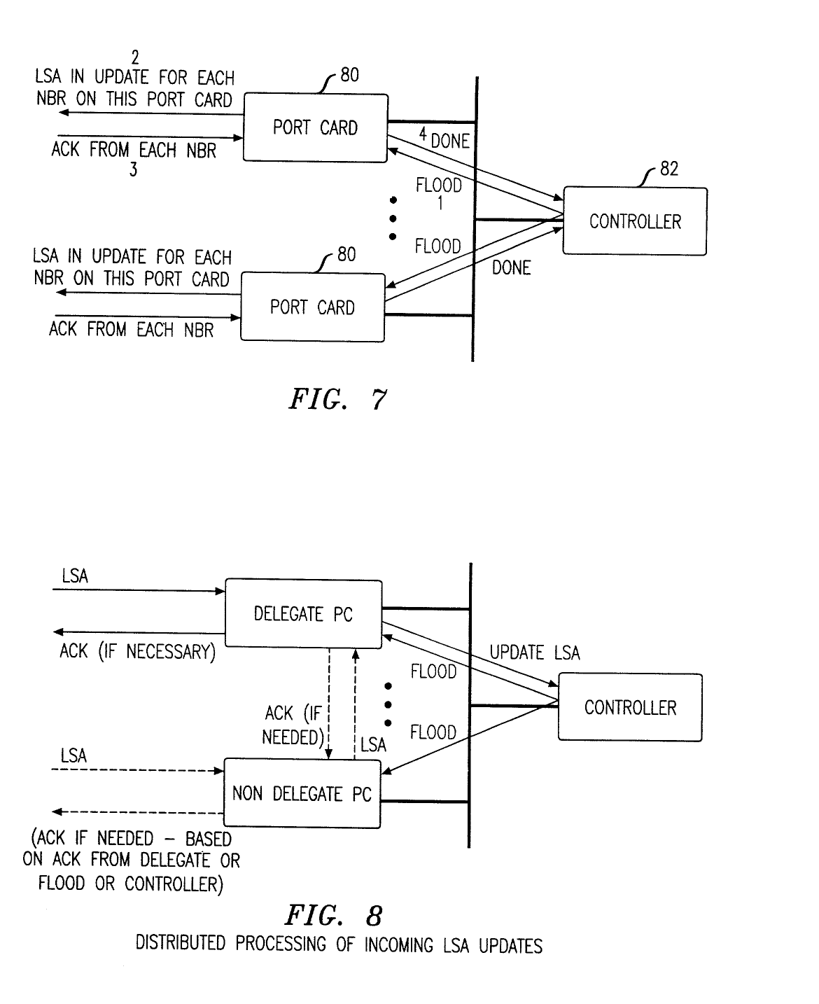

For each interface over which a node is communicating OSPF to one or more neighbor nodes, that node maintains an OSPF interface finite state machine (FSM) which keeps track of the underlying interface state and the capacity in which OSPF is interacting with its neighbors on this interface, where the node could be a DR, BDR, DROther or P2P (point to point). An exemplary interface FSM 60 is shown in FIG. 3. A neighbor finite state machine for each neighbor that was discovered/configured on this interface is also maintained, where this state machine tracks the state of the communication between this node and the neighbor over this interface. An exemplary neighbor FSM 70 is shown in FIG. 4.

Each LSA in the LSDB is aged with time. For self originated LSAs, each LSA is refreshed periodically. When the age of a self originated LSA reaches maxage, the LSA is first flushed out of the OSPF domain by flooding the maxage LSA and then re-originated the LSA with the initial age. For the LSAs originated by other nodes, if the age reaches maxage, the LSAs are removed from the LSDB as soon as they are not involved in the process of initial database synchronization with any of their neighbors. If for any reason, a node wants to flush one of its self-originated LSAs from the OSPF domain, the node sets the LSA's age to maxage and floods it.

Establishing and Maintaining Neighbor Relationships

Various types of OSPF messages are exchanged between neighbors, such as: Hello packets, Database description packets, Link state request packets, Link state update packets, Link state ack packets, exemplary uses of which are described.

When the OSPF protocol is enabled on an interface, hello packets are periodically multicast on that interface. Hello packets are used to first discover one or more neighbors and where necessary carry all the information to help the DR election process. Among other things, hello packets also carry the identities of all other routers from which the sending node has received hello packets. When a node receives a hello packet that contains its own identity, the receiving node concludes that bi-directional communication has been established between itself and the sender of the hello packet. When bi-directional connectivity is established, the node decides the capacity in which it must be an OSPF speaker on this interface. At the point when a node must decide whether or not to establish an adjacency with a particular neighbor over one of its interfaces, the OSPF FSM for that interface would be in one of P2P, DR, BDR or DROther states and the OSPF neighbor FSM for that neighbor would be in state TwoWay. If the decision is not to establish an adjacency, the neighbor FSM stays in state TwoWay. This decision is re-evaluated whenever the OSPF speaker capacity changes.

Once the capacity is established, the two neighboring nodes must decide if they indeed should exchange their LSDBs and keep them in sync. If database exchange needs to be performed, a neighbor relationship (adjacency) is established. For example, if a node is speaking OSPF in the capacity of DROther over an interface, it would decide not to establish an adjacency with another router that is participating as DROther on that interface—DROther speakers only establish adjacencies with DR and BDR speakers.

Once the neighbor relationships (adjacencies) are established and the DR election is done, hello packets are used as keep-alives for maintaining the adjacency and are also used in monitoring any changes that can potentially result in changes in the DR status. Note that a newly identified neighbor can alter the capacity in which the node was speaking on that interface prior to this neighbor being identified. If this is the case, some previously established adjacencies may have to be re-established/terminated.

Initial LSDB Synchronization

If the decision is to establish an adjacency, the node is agreeing to keep its LSDB synchronized with its neighbor's LSDB over this interface at all times. At this time the neighbor FSM for this neighbor is in state ExStart. The node enters a master/slave relationship with its neighbor before any data exchange can start. If the neighbor has a higher id, then this node becomes the slave. Otherwise, it becomes the master. When the master/slave relationship is negotiated, the neighbor FSM enters state Exchange.

The LSDB synchronization is achieved in two parts. In a first part, all LSAs in the LSDB, except the ones with maxage, at the time of the transition into state Exchange are recorded. This information is summarized and sent to the neighbor in data description packets. When the neighbor receives this summary information, it compares the summary with the contents of its own LSDB and identifies those LSAs that are more recent at this node. The neighbor then explicitly requests these more recent LSAs by sending link state requests packets to this node. This node then responds to the link state request packets by sending the requested LSAs in link state update packets to the neighbor and the neighbor is included in the flooding procedure Note that, in the above, once the summarization of the LSAs is done, sending data description packets to the neighbor, responding to link state requests from the neighbor and also including the neighbor in the flooding procedure can all happen concurrently. When this node has sent the whole summary of its LSDB in data description packets to the neighbor and also has received a similar summary from its neighbor, the neighbor FSM transitions into either the Loading or the Full states. It transitions into Loading if it is still expecting responses to the link state request packets it sent to the neighbor. Otherwise, it transitions to state Full. Note that due to the concurrency aspect mentioned earlier, it is possible that all of a node's link state requests are already responded to even before the node has finished sending all of its data description packets to its neighbor. In this case, as soon as all the data description packets are sent to the neighbor, the neighbor FSM transitions directly from state Exchange to Full. When the neighbor FSM transitions to Full, this node includes this interface in the router LSA that it generates.

Reliable Flooding Procedure

The OSPF flooding procedure is invoked in two scenarios. A first scenario is when a node intends to originate/refresh an LSA and second scenario is when it receives a new LSA or an update to an existing LSA from its neighbor.

When an updated non self-originated LSA “L” is received from a neighbor N, one of following scenarios can occur:

A first is that no previous instance of L exists in the LSDB; i.e., L is a new LSA. If the age of L is maxage and if there are no neighbors in the dbexchange process, then send an ack to N and discard L. Otherwise, timestamp L, ack it and install in the LSDB.

A second is that an older version of L exists in the LSDB. If the older version was received less than minLSarrival time ago, L is discarded. Otherwise, timestamp L, ack it and install in the LSDB. If there are any neighbors from whom this node is expecting acks for the older version of L, stop expecting such acks.

A third scenario is a newer version of L exists in the LSDB. Three cases are of interest here: 1) If N and this node are still in the dbexchange process, and if N had previously sent a database description packet suggesting that it had a newer version than the one in the LSDB, then this is an error. The db xhange process with N has to start all over again. 2) If the age of the newer version is maxage and its sequence number is maxseqno, then discard L. The intent here is to let the seqno wrap around. 3) If the newer version was received more than minLSinterval time ago, then send the newer version of L to N. Do not expect an ack from N and do not send an ack for L.

A fourth scenario for self-originated LSAs is where the version in the LSDB is the same as L. In this case, check if this is an implicit ack. If it is an implicit ack, then no need to ack it unless N is the DR. If not treated as an implicit ack, send an ack to N.

If L was installed in the LSDB above, then it needs to be sent to all neighbors except N and other DROther/BDR speakers for which N is the DR (note that if this node was part of more than one area, then the scope of flooding for L would depend on the LSA type of L). In order to ensure reliable delivery of L to its neighbors, L is retransmitted periodically to each neighbor M until an ack is received from M. An ack could be implicit. In the last scenario above, L could be treated as an implicit ack from N if this node was waiting for an ack from N for the version in the LSDB.

When sending L to a neighbor M with which this node is in exchange/loading state, L must be compared with the instance of L that was described in the database description packets sent by M. Two cases are of interest here are: 1) L is an older version, where in this case, no need to send L to M; and 2) L is the same or more recent, where in this case, it is no longer necessary to request the version of L from M. In this case, L is no longer asked for when sending link state request packets to M. If M and N are on the same broadcast/NBMA interface and if N is the DR, then it is not necessary to send L to M. In all other cases send L to N.

Note that the above procedure sometimes causes acks to be received even when they are not expected. Such acks are simply discarded. A maxage LSA L is removed from the LSDB when no acks are expected for L from any neighbor and this node is not in exchange/loading state with any of its neighbors. In some cases, a node can receive a self-originated LSA L from one of its neighbors N. If L if more recent than the one in the LSDB (L must have been originated by a previous incarnation of this node), then this node must either flush L by setting its age to maxage and flooding it, or it must originate a newer instance of L with its sequence number being one more than that of L.

Whenever the contents of the LSDB change, the routing table is appropriately updated. This may include an SPT computation. In more recently proposed uses of the LSDB, such changes may lead to recomputation of, for example, MPLS explicit paths.

A Distributed OSPF Implementation

An aim of the present invention is to distribute the OSPF protocol implementation without having to make assumptions on distributability of other routing protocols. For this reason, it is important that the route table computation be centralized on the main controller card of a router. This is because a given route table computation often requires interaction with information gleaned by other routing protocols and also with provisioned policy information.

Given that the route table computation has to be performed at the controller card, the whole of the LSDB has to be stored on the controller. However, for each LSA, in accordance with the present invention, a delegate port card is assigned. Therefore, the delegate port card also has a copy of the LSAs for which it serves as the delegate. The delegate is responsible for performing acceptance checks for the LSAs it serves. If an LSA is received by a port card which is not a delegate, that port card just forwards it to a delegate port card if known; otherwise, it sends the LSA to the controller.

Each port card also maintains a copy of the interface FSM and the neighbor FSMs for the interfaces that it owns. The delegation of LSA processing to port cards is done based on some load balancing heuristic. For example, the total number of LSAs are partitioned equally among all the port cards. The delegate also performs the checkage and refresh functionality for the LSAs it is handling.

Establishing and Maintaining Neighbor Relationships

When the OSPF protocol is enabled on an interface, the controller delegates the hello processing and neighbor discovery aspect to the port card that has this interface. Sending and receiving of hello packets is then performed by the port card. FIG. 5 shows an exemplary arrangement of a port card 80 and controller 82 in accordance with the present invention. Every time a new event for the interface FSM needs to be generated based on incoming hello packet processing, the port card 80 sends this event to the controller 82. This ensures that the port card 80 and the controller 82 have synchronized interface FSMs. The controller 82, however, typically does not maintain any timers, but just monitors the functional status of the port card 80. Timers are typically maintained at the port card 80. Note that the port card expects an ack for the events it sends to the controller.

The port card 80 also maintains a copy of the neighbor FSM for each neighbor discovered through the hello mechanism. The port card 80 is also responsible for executing the DR election procedure. Once the neighbor FSM reaches the state TwoWay, the port card has enough information to decide if it should advance to ExStart. If this is required, the port card 80 sends an event to the controller 82 to initiate the database exchange process. The controller 82 sends an ack for this to the port card 80 when the master/slave negotiation is done.

If the port card is swapped out for any reason during this process, OSPF connectivity on all the interfaces on the port card are considered to be lost and the interface and neighbor FSMs are updated appropriately at the controller. The assumption here is that the controller somehow comes to know about the port card being not available.

Initial DB Exchange

Creation of database description packets requires access to the entire link state database. Therefore, this is done by the controller itself. The controller also sends the link state request packets. However, during the link state request creation process, if it encounters any new LSAs that were not already delegated, it delegates the processing of those to the port cards. The initial db exchange process is illustrated in FIG. 6.

When the neighbor FSM at the controller 82 reaches the Full state, the controller 82 sends an event to the port card 80 maintaining a copy of the neighbor FSM to update its state to Full. This is necessary for the port card 80 to make correct flooding scope decisions. Once again, if the port card is swapped out for any reason during this process, OSPF connectivity on all the interfaces on the port card is considered to be lost and the interface and neighbor FSMs are updated appropriately at the controller.

Note also, that the incoming link state request packets are directly served by the controller. This avoids any age discrepancy between the age in the database description packets and the LSA itself The load offered on the controller due to processing of data description and link state request packets is not very high because, there can only be one outstanding packet of each of these types per neighbor. Moreover, the number of neighbors simultaneously in the db exchange phase can be limited through configuration.

Flooding

When an LSA needs to be sent out from a node to all its neighbors, the controller initiates this by broadcasting the LSA to all the port cards. Each port card then sends the LSA to the appropriate neighbors connected on through the interfaces on that port card as part of the link state update packets. As would be understood by a person skilled in the art, if area design is used, all neighbors would not be sent to, and scoping (flooding to neighbors in the same area) the neighbors would be a minor change to the instant procedure.]

The port cards handle all the issues of retransmission and acknowledgement related logic including implicit acknowledgements. When the port card receives acks from all the neighbors, the port card sends a done event to the controller. An exemplary flooding procedure is illustrated in FIG. 7, where the corresponding sequential events are labeled 1-4.

Note that for the present invention, it is assumed that the flood and done events are exchanged between the port cards 80 and the controller 82 in a reliable manner. The flooding of an LSA is considered complete when all port cards 80 respond with a done event. LSAs arriving at a node are received in link state update packets. The receiving port card 80 checks the LSA validity and then extracts each LSA from it. For each LSA extracted, the port card checks if it is the delegate for it. If not, it forwards the LSA to the delegate port card—if a delegate is not known the LSA is forwarded to the controller 82. The port card does not maintain any state for LSAs for which it is not the delegate.

If it is the delegate, the corresponding port card checks if the age for the LSA is maxage. If so, the port card ceases to be the delegate and forwards the LSA to the controller. Otherwise, it checks if this LSA should be accepted. If not, the port card sends an ack to the sending neighbor, if necessary. Otherwise, this LSA needs to be accepted and is forwarded to the controller. The delegate port card does not send an ack to the neighbor until the controller decides to flood that LSA. The flood event acts as an implicit acknowledgment that the controller has received at least the required version of the LSA. When the flood event is received, the port card decides if an explicit ack needs to be sent to the neighbor. If so required, it sends the ack. Note that sending of the LSA to the controller does not require reliable communication. If it doesn't get through, the neighbor will time out and re-send anyway.

A delegate port card 80 can get an LSA from another port card 86. In this case, the processing is the same as above, except that the ack is sent through the port card 86 that originally received the LSA. If the LSA is accepted by the delegate and passed on to the controller, a minor optimization to the above is possible. The port card that originally received the LSA can send back an ack to the sending neighbor based on the flood from the controller. Once again, note that no reliable communication is needed in this scenario. The above exemplary procedure for handling incoming LSAs are illustrated in FIG. 7.

In addition to the above, when self-originated LSAs need to be refreshed, the delegate port card 80 informs the controller that the LSA needs to be re-originated. The controller then floods a new instance of the requested LSA and the delegate updates its copy with the new one. The indication from the delegate port card to the controller has to be reliable. If the number of self-originated LSAs is small then the controller itself may take responsibility of keeping track of the last refresh time. If this responsibility is indeed delegated to a port card and the port card dies, then the controller must compare the time of death of the port card with the timestamp of self-originated LSAs for which the dead port card was a delegate. The controller may either delegate to another port card indicating the remaining time for the refresh, or postpone this delegation until the next refresh and keep track of the refresh timer itself. In addition to taking over the refresh functionality, the controller must also handle the checkage functionality.

The Issue of LS Age

For the correct implementation of the procedures described above, it is essential that the aging of LSAs is done consistently among the controller and the delegate port cards. This is because the LSA acceptance procedure for incoming LSAs depends on the comparison of the age of the incoming LSA to that of the LSA existing in the LSDB.

To achieve consistency, the controller floods a timer “tic” to all the port cards. The port cards use this tic in updating the age of their copies of the LSAs. This ensures that the age of the LSA on the port card is always less than or equal to that on the controller. Accordingly, if a delegate port card dies and the controller has to take over the responsibility of an LSA, the situation is no worse than a temporary clock speedup at an OSPF node. The comparisons for any subsequent retransmissions from a neighbor would be consistent with the previous comparisons performed by the dead delegate.

Note that the above procedure can be made more robust by requiring each port card to ack after every x number of ticks for some allowable drift of x seconds. The OSPF protocol itself is robust up to drift of 15 minutes and does not require participating nodes to keep their clocks synchronized.

In another embodiment of the invention, before an LSA update is sent from a delegate port card 80 to the controller 82, the LSA can be preprocessed and presented in a form where the controller spends much less CPU time in processing it. LSA updates can also be sent in batches to reduce the number of messages.

One example of preprocessing is: given the way router LSAs are structured, for each link described in it, the node reachable using that link has to be searched from the set of all the router LSAs using the router id. As the number of nodes and links increases, an SPT computation may require m searches, one for each link, on a set of n nodes. In the best case, each of these m searches is O(log n). Preprocessing can be performed to make this O(log n) operation into O(1) on the controller. The search overhead is now on the delegate port card and is distributed among a number of port cards. Note that while this overhead is not significant for infrequent SPT computation, it could become significant in an unstable network.

The foregoing description merely illustrates the principles of the invention. It will thus be appreciated that those skilled in the art will be able to devise various arrangements, which, although not explicitly described or shown herein, embody the principles of the invention, and are included within its spirit and scope. For instance the terms link state advertisements and hello packets would be meant to be applicable to other such routing protocols having similar functionalities, such as PNNI and ISIS, and not only be limited to the OSPF routing protocol. It would also be understood that a delegate port card need not be embodied in a separate physical card, but that only a separate distributed processing functionality be present. Furthermore, all examples and conditional language recited are principally intended expressly to be only for instructive purposes to aid the reader in understanding the principles of the invention and the concepts contributed by the inventor to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

In the claims hereof any element expressed as a means for performing a specified function is intended to encompass any way of performing that function including, for example, a) a combination of circuit elements which performs that function or b) software in any form, including, therefore, firmware, microcode or the like, combined with appropriate circuitry for executing that software to perform the function. The invention as defined by such claims resides in the fact that the functionalities provided by the various recited means are combined and brought together in the manner which the claims call for. Applicant thus regards any means which can provide those functionalities as equivalent as those shown herein. Many other modifications and applications of the principles of the invention will be apparent to those skilled in the art and are contemplated by the teachings herein. Accordingly, the scope of the invention is limited only by the claims appended hereto.

1. An apparatus for communicating a link state routing protocol with nodes in a network, comprising:
a controller having at least one processor associated therewith for performing route calculation and maintaining a link state database of said network; and
at least one delegate port card coupled to said controller and having at least one separate processor associated therewith, said delegate port card having selected software functionality of said link state routing protocol assigned thereto, said delegate port card operable to process communications associated with said selected software functionality substantially independently of said controller.

2. The apparatus of claim 1, wherein said routing protocol is selected from the group consisting of OSPF, PNNI and ISIS.

3. The apparatus of claim 1, wherein said controller is updated when a state change therefor occurs.

4. The apparatus of claim 1, wherein said delegate port card is operable to distribute link state advertisements assigned thereto and to perform acceptance checks for said link state messages served thereby.

5. The apparatus of claim 1, wherein said delegate port card is operable to process incoming LSA updates.

6. The apparatus of claim 1, wherein said delegate port card is operable to perform refresh functionality for associated LSAs.

7. The apparatus of claim 1, delegate port cards are operable to provide retransmission timers and acknowledgements for LSA updates.

8. The apparatus of claim 1, wherein sending and receiving of hello packets is performed by the delegate port card.

9. The apparatus of claim 1, wherein neighbor finite state machines are synchronized between said controller and said delegate port card, said controller being updated by said delegate port card upon a new event being generated for said neighbor finite state machine.

11. The apparatus of claim 1, wherein a LSA flood is initiated by said controller broadcasting said LSA to all port cards, wherein said port cards provide retransmission and acknowledgement service related thereto.

12. The apparatus of claim 1, wherein said controller floods a tic timer to all delegate port cards.

13. The apparatus of claim 12, wherein said delegate port cards send an acknowledgement after a given number of tics being received.

14. The apparatus of claim 1, wherein LSA updates from delegate port cards are preprocessed before being sent to said controller.

15. A distributed processing apparatus for enabling distributed functionality of OSPF to be handled by delegate processors of a router, said router including a controller having at least one processor performing route calculation and maintaining a link state database in connection with a network, said apparatus comprising:
one or more communication ports for communicating to nodes in said network of said router; and
at least one processor operable to perform selected OSPF functionality substantially independent of said controller, said controller being updated upon receipt by said port card of an altering event to a state machine in said controller.

16. The apparatus of claim 1, wherein said delegate port card is operable to distribute link state advertisements assigned thereto and to perform acceptance checks for said link state messages served thereby.

17. The apparatus of claim 1, wherein said delegate port card is operable to process incoming LSA updates.

18. The apparatus of claim 1, wherein sending and receiving of hello packets is performed by the delegate port card.

19. A method for communicating an intra-autonomous system link state routing protocol with nodes in a network, said method comprising:
performing route calculation and maintaining a link state database of said network on at least one processor of a controller device; and
providing selected software functionality of said intra-AS link state routing protocol on a distributed basis using a distributed processor operable to process communications associated with said selected software functionality substantially independently of said controller.

20. The method of claim 19, wherein said controller is updated upon receipt by said distributed processor of an altering event to a state machine in said controller.
